(19) United States
(12) Patent Application Publication
(10) Pub. No.: US 2016/0219677 A1
(43) Pub. Date: Jul. 28, 2016

(54) Lighting Systems And Methods

(71) Applicant: Eventide Inc., Little Ferry, NJ (US)

(72) Inventors: Richard C. Factor, Little Ferry, NJ (US); Don S. Elwell, Millstone Township, NJ (US)

(21) Appl. No.: 15/005,168

(22) Filed: Jan. 25, 2016

Related U.S. Application Data
(60) Provisional application No. 62/107,718, filed on Jan. 26, 2015.

(51) Int. Cl. H05B 37/02; H04R 1/40; G10L 25/63; H04N 21/439

(52) U.S. Cl. CPC H05B 37/0236; H05B 37/0272; H04N 21/4394; H04R 1/406; G10L 25/63; H04R 2201/401

(57) ABSTRACT

A lighting system is disclosed, which comprises one or more lights, a processing system having a processor and a memory communicatively coupled to the processor. The processor has instructions configured to analyze an audio signal and determine the mood of audio associated with the audio signal based off a variety of descriptors embedded in the audio signal. A signal generator communicatively coupled to each light also forms part of the system, the signal generator being operative to generate a signal reflective of the determined mood for receipt by each light, wherein light output from each light is altered in response to the signal received by the signal generator.

### CROSS-REFERENCE TO RELATED APPLICATIONS

The present application claims the benefit of the filing date of U.S. Provisional App. No. 62/107,718, filed Jan. 26, 2015, the disclosure of which is hereby incorporated by reference herein.

### BACKGROUND OF THE INVENTION

The present invention generally relates to lighting systems that are responsive to, for example, the mood detected in a piece of music.

The lighting in a particular environment or at a specific event preferably should reflect the mood of the environment or event, as determined by a variety of factors. Existing lighting systems, however, are unable to spontaneously react to the mood of, for instance, a piece of music being played in the environment or at the event at issue. Typically, lighting must be altered by professionals or pre-planned to reflect the mood of an event. Using dedicated personnel to dynamically alter lighting in response to changes in mood is cost intensive and, therefore, is usually reserved for those willing to undertake the cost (e.g., at more high-profile events, etc.)

A need therefore exists to provide a dynamic lighting system that is automatically responsive to certain stimuli, such as mood.

### BRIEF SUMMARY OF THE INVENTION

A first aspect of the invention includes a lighting system that comprises one or more lights, an audio sensor, and a processing system having one or more processors and a memory communicatively coupled to each processor, each processor having instructions configured to analyze an audio signal received from the audio sensor, and determine the mood of audio detected by the audio sensor based off a variety of descriptors embedded in the audio signal. The system also comprises a signal generator communicatively coupled to each light, the signal generator being operative to generate a signal reflective of the determined mood for receipt by each light, wherein light output from each light is altered in response to the signal received by the signal generator.

In embodiments of this first aspect, the audio sensor is a microphone, optionally having directional capabilities. In addition, the color, intensity, and/or modulation of light output from each light may be altered in response to the signal received by the signal generator so as to match the determined mood of the audio associated with the audio signal.

A second aspect of the invention includes a lighting system comprising one or more lights and a processing system having a processor and a memory communicatively coupled to the processor, the processor having instructions configured to analyze an audio signal and determine the mood of audio associated with the audio signal based off a variety of descriptors embedded in the audio signal. The system also comprises a signal generator communicatively coupled to each light, the signal generator being operative to generate a signal reflective of the determined mood for receipt by each light, wherein light output from each light is altered in response to the signal received by the signal generator.

In an embodiment of this second aspect, the processor includes instructions for running a mood algorithm configured to analyze the variety of descriptors embedded in the audio signal and determine the mood of the audio associated with the audio signal based off the descriptors. In another embodiment, the descriptors include a combination (or all) of the following:

| Type | Features |
|---|---|
| Low level | barkbands spread, skewness, kurtosis, |
| | dissonance, hfc pitch and confidence, pitch |
| | salience, spectral complexity spectral crest, |
| | spectral decrease, energy, spectral flux spec |
| | spread/skewness/kurtosis, spec rolloff, |
| | strong peak ZCR, barkbands, mfcc |
| Rhythm | bpm, beats loudness, onset rate |
| Sound FX | inharmonicity, odd2even, pitch centroid, |
| | tristimulus |
| Tonal | chords strength (frame), key strength |
| | (global), tuning freq |

A third aspect of the invention includes a method of altering lighting comprising: (1) providing a processor, a memory communicatively coupled to the processor, a signal generator, and one or more lights; (2) generating and sending an audio signal to the processor; (3) analyzing the audio signal via the processor to determine the mood of audio associated with the audio signal, the analyzing step comprising assessing descriptors embedded within the audio signal determinative of the mood of the audio; (4) outputting a signal via the signal generator that is representative of the mood of the audio, as determined in the analyzing step; and (5) altering light generated by the one or more lights in response to the signal so that the generated light reflects the mood of the audio determined in the analyzing step. Although the steps of this method are numbered above, no particular order is implied by such numbering.

In an embodiment of this third aspect, the signal is a wireless signal sent from the signal generator to a receiver associated with the one or more lights.

A fourth aspect of the invention includes a method of altering the output of an electronic device comprising: (1) providing a processor, a memory communicatively coupled to the processor, a signal generator, and one or more electronic devices operable to output human-perceptible media; (2) generating and sending an audio signal to the processor; (3) analyzing the audio signal via the processor to determine the mood of audio associated with the audio signal, the analyzing step comprising assessing descriptors embedded within the audio signal determinative of the mood of the audio; (4) outputting a signal via the signal generator that is representative of the mood of the audio, as determined in the analyzing step; and (5) altering the quality or content of human-perceptible media output from the electronic device in response to the signal so that the human-perceptible media reflects the mood of the audio determined in the analyzing step.

In embodiments of this fourth aspect, the electronic device is a video display means and the human-perceptible media is video.

### BRIEF DESCRIPTION OF THE DRAWINGS

A more complete appreciation of the subject matter of the present invention and the various advantages thereof can be realized by reference to the following detailed description, in which reference is made to the accompanying drawing(s):

FIG. 1 illustrates an embodiment of a lighting system according to the present invention, and its operation.

### DETAILED DESCRIPTION

In describing certain features of the present invention, specific terminology will be used for the sake of clarity. However, the invention is not intended to be limited to any specific terms used herein.

Embodiments of the invention relate to lighting systems that automatically detect and react to certain stimuli, such as music (e.g., the mood of music) and alter the output of the system in response to the stimuli. In one example, a particular piece of music may be playing at an event, such as a disc jockey performing at a club, or music playing at an art exhibit or another event, and the lighting associated with the event may automatically change in response to the perceived mood of music playing at the event. In one case, if the mood of the music playing at a particular moment was “excited,” the lighting system could detect such excitement and change its output to match the excitement of the music (e.g., the lights associated with the system could flash frequently, move in random directions, etc.) The details of such a lighting system are set forth more fully below.

A means for detecting the mood of music based off a variety of factors (so-called “descriptors”) is described in the following dissertation—Cyril Laurier, Automatic Classification of Musical Mood by Content-Based Analysis (Universitat Pompeu Fabra) (2011), available at http://mtg.upf.edu/people/claurier/ (hereinafter, the “Laurier Dissertation”), which is hereby incorporated by reference herein in its entirety. Certain portions of the Laurier Dissertation are referenced below.

The Laurier Dissertation describes determining the “mood” of a song using certain criteria measurable in the audio signal (e.g., the raw audio signal) of the song. These “audio descriptors” are variables extracted from the audio signal, which describe some aspect of the information the signal contains. An example of some of the descriptors that can be used to determine the mood of a song are shown in the table below (Table 4.11 of the Laurier Dissertation):

| Type | Features |
|---|---|
| Low level | barkbands spread, skewness, kurtosis, |
| | dissonance, hfc pitch and confidence, pitch |
| | salience, spectral complexity spectral crest, |
| | spectral decrease, energy, spectral flux spec |
| | spread/skewness/kurtosis, spec rolloff, |
| | strong peak ZCR, barkbands, mfcc |
| Rhythm | bpm, beats loudness, onset rate |
| Sound FX | inharmonicity, odd2even, pitch centroid, |
| | tristimulus |
| Tonal | chords strength (frame), key strength |
| | (global), tuning freq |

In general, through the use of the aforementioned descriptors, the mood of a piece of music can be classified into different categories. For purposes of this disclosure, such categories are “excited,” “happy,” “relaxed,” and “sad.” The categories may be binary, in that a particular song or portion of a song may be excited or not exited, happy or not happy, relaxed or not relaxed, and/or sad or not sad. Similarly, the song or portion of the song may not be exclusive to a category, in that the song or portion of the song can be, for example, both happy and relaxed. Other groupings are also possible, of course, as described in detail in the Laurier Dissertation. As also disclosed in the Laurier Dissertation, an algorithm is used to analyze the foregoing descriptors and determine the mood of a particular song or piece of music (or portion thereof). An example of an algorithm used for this purpose is the SVM algorithm taught in the Laurier Dissertation. The raw audio signal may be analyzed using the chosen algorithm and the mood of the song or portion thereof can be determined via the algorithm.

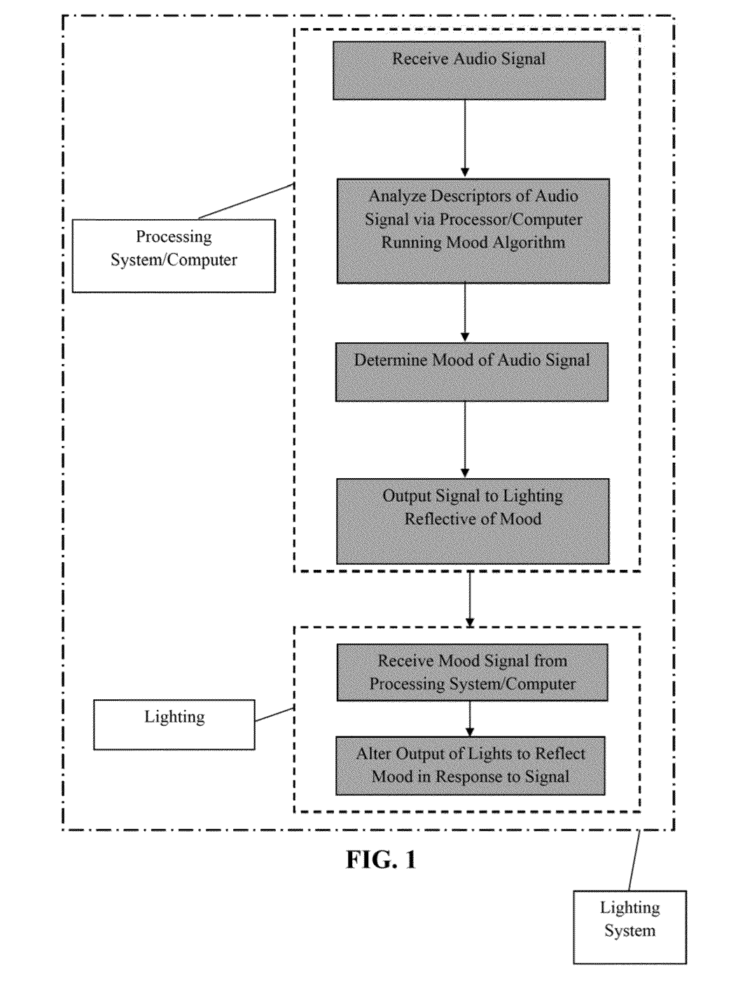

Turning to FIG. 1, an embodiment of the present invention includes a lighting system that is dynamically adjustable in response to music. The lighting system generally includes a processing system or a computer that is configured to receive an audio signal associated with a piece of music, the processing system/computer can then analyze the signal and determine the music's mood, and subsequently output a command to a light or series of lights to change the output thereof (e.g., to reflect the determined mood of the music). In this manner, the lighting system of FIG. 1 is dynamically responsive to the mood of a particular piece of music or portion thereof.

Referring still to FIG. 1, the processing system/computer includes a processor or multiple processors having instructions for running a mood algorithm of the type described above (e.g., the SVM algorithm disclosed in the Laurier Dissertation). In an alternate embodiment, a processor (or multiple processors) is instead incorporated into each light of the lighting system as opposed to in the processing system/computer. In either case, a memory is communicatively coupled with the processor(s) for performing processing functions. As an example, the processor(s) includes instructions for running the mood algorithm, which is capable of analyzing a variety of descriptors present in the audio signal of a piece of music to determine the mood of the music. The processing system/computer is therefore configured to analyze the audio signal (e.g., a raw audio signal) via the processor(s) and determine the mood of audio tied to the audio signal by way of the mood algorithm running on the processor(s).

In an embodiment, the processor(s) is also associated with a signal generator, which communicates with the lights of the lighting system. Such communication may be through wireless technology, for example through Bluetooth, a wireless local area network using IEEE 802.11, or through radio communications. Alternatively, hard-wired technology may be used. In the case of wireless communication, the lights may include a receiver for receiving a signal from the signal generator.

The lighting system may further include one or more microphones optionally having directional capabilities, each of which is operable to receive audio and convert it to an audio signal for processing by the processor(s). For instance, in an embodiment the processing/computer system includes the one or more microphones (optionally having directional capabilities). In another example, one or more microphones are embedded into the lights themselves so that each light is operable to receive the audio signal via a dedicated microphone(s). In yet another case, one or more microphones, with or without directional capabilities, may be common to an array of lights to assist in controlling those lights. In still another variant, the lighting system may not include a microphone and the processing/computer system may instead be tied directly into the audio signal so that a microphone is not needed. Stated another way, the processing/computer system may be configured to directly receive the raw audio signal from the device playing music or it may be the device itself (e.g., a music player), in which case a microphone detecting audio and converting it to an audio signal is not needed. Thus, different combinations of the lighting system are possible to achieve a dynamic lighting system of the type disclosed herein.

An example of the operational process for the above-described lighting system is depicted in FIG. 1. As shown, an audio signal is first received by the computer/processing system. The audio signal can be received in any of the ways detailed above. For instance, the computer/processing system may be directly tied into the audio signal or a dedicated microphone(s) embedded into a light or common to an array of lights may receive music, convert it into an audio signal, and send such a signal to the computer/processing system. After receipt, the audio signal is processed by the processor(s) so that a set of pre-defined descriptors embedded in the signal are analyzed via the processor(s) (e.g., any of the above-noted descriptors or others identified in the Laurier Dissertation). The descriptors can be weighted in any manner described in the Laurier Dissertation, in particular as detailed in Chapter 4. Indeed, any mood algorithm can be embedded into the processor and used to analyze the descriptors of the audio signal (e.g., the SVM algorithm identified in the Laurier Dissertation, or any other disclosed algorithm). With the appropriate mood algorithm running, the audio signal can be analyzed by the processor(s), which determines the mood of the song or portion of the song playing (e.g., a happy, relaxed segment of the song or entire song). This is the “determine mood of audio signal” step of FIG. 1. Based off the mood determined by the processor(s) running the algorithm, a signal is then output by the signal generator of the processing/computer system and sent to the light or lights associated with the processing/computer system. As described, a wireless or wired signal may be sent from the processing system/computer to the light or lights via the signal generator. If a wireless signal is sent, the light or lights may receive the signal via the light's receiver.

After receiving the signal from the processing system/computer, light output from the light or lights may be altered to reflect the mood of the song or portion of the song, as previously determined by the processing system/computer (FIG. 1). For instance, one or more of the following may be adjusted in response to the signal output from the processing system/computer: color, intensity, direction, and/or modulation of the lights. In the case of a happy and relaxed song or portion of a song, for example, the lights may be altered to have a pleasing color and intensity, with little to no modulation. The opposite may be true for an excited song or portion of a song in that the lights may be altered to have a greater intensity with more modulation to coincide with the excited nature of the song. The light or lights may receive the signal output from the signal generator via the light's receiver, and convert the signal into an electrical signal usable to change the light's output (e.g., in terms of intensity, color, and/or modulation). Alternatively, the signal output from the signal generator may directly alter the light's characteristics.

Thus, a lighting system is contemplated that may be automatically altered in response to different audio stimuli. This is useful in many different contexts, such as to mesh lighting with the theme or mood of an event, to alter lighting at a concert or a DJ performance, etc. Many applications are contemplated, even those in the home. As an example, a user in his or her home environment could have a lighting system as described herein, which is responsive to the mood of music playing in the home. Such a lighting system could create an overall pleasing environment if, as an example, a happy and relaxed song or portion of a song were playing. The user could also select a subset of music he or she wants to listen to that corresponds to the particular “mood” that user is in, and the lighting system in the home could adapt accordingly.

An aspect of the invention described above also includes a lighting system that is, by itself, automatically adjustable in response to the mood of a piece of a music or portion thereof. In other words, individual lights or arrays of lights, by themselves, may be configured to be dynamically adjustable (e.g., as a “smart” lighting system). In a particular embodiment, such a smart lighting system may include one or more microphones, optionally having directional capabilities, that are embedded into individual lights of the system to allow each light to adapt in response to music playing in the area of the light. In the alternative, with an array of lights, each light may not have a dedicated microphone and instead one or more microphones may be common to a particular array. Multiple microphones may also be associated with (e.g., embedded in) a singular light. The lights or the array forming the lighting system may further include their own processor, memory, and signal generator for altering the output of the light or array. Thus, with a microphone(s) associated with each light or common to an array of lights, the lights may simply be plugged into a power source and be immediately operable to respond to the detected mood of a piece of music or portion thereof.

The use of the above “smart” lighting system, in one embodiment, is as follows. Initially, music playing in a particular location may be received from the microphone(s) that is embedded into each light or common to an array of lights. The microphone(s) then converts the music into a raw audio signal for processing by the processor(s) embedded in each light of common to the array. After receipt of the audio signal from the microphone(s), the processor(s) analyzes the signal via a mood algorithm running on the processor(s) and determines the mood of the audio associated with the audio signal. Thus, the audio signal is analyzed in much the same way as described previously (e.g., through the use of a mood algorithm pre-programmed into the processor(s)). Once the mood of the song or portion of the song associated with the particular light or array of lights is detected, the determined mood is output by the signal generator embedded within the light or associated with the array. In response to the signal received by the signal generator, the light or array then automatically adjusts to reflect the mood of the song or portion of the song playing at the time, for example by altering color, intensity, and/or modulation of the light or array of lights. Thus, in this “smart” lighting system, an individual light or an array of lights is operable apart from a separate processing/computer system since the processing/computer system is associated directly with each light or is common to an array of lights. A user could therefore purchase said light or array of lights and simply connect the light or array to a power source for dynamic operation of the lighting system.

It may also be the case that, due to the directionality of the microphone(s) used with each light or array of lights, different rooms could be subject to different lighting schemes. As an example, at an event where one room is themed in one way and another room is themed a different way, the directionality of the microphone(s) used with each light or array of lights could isolate sounds from other rooms to keep the theme of the particular room consistent. The light or array of lights in the particular room could therefore adjust automatically to reflect the mood of the music in that particularly-themed room or area, excluding the mood of music in another differently-themed room or area.

Although the foregoing embodiments are described as utilizing certain structures, others may also be employed and are equally contemplated within the scope of the invention. For example, common computing components beyond those set forth above may form part of the lighting system, to the extent necessary to provide a dynamic lighting system as disclosed above. Such computing components are known to those of skill in the art, and would be apparent in light of the description. Further, although a certain set of descriptors is disclosed, it is to be understood that any of the descriptors detailed in the Laurier Dissertation, in any combination, may be usable with the present invention to discern the appropriate mood of a song and its consequent effect on lighting.

In addition, while the above system is described in the context of altering the output of lights, it can also be used to alter the output of other electronic devices such as, for example, televisions, projectors displaying images or video (e.g., computer-generated patterns), smoke generators, scent machines, electronic video displays, or other like devices. For instance, these electronic devices may be associated with a processing system/computer (having one or more processors) and a signal generator, which are configured to analyze the mood of music as described above and change the output of the relevant electronic device via the signal generator. As an example, upon detecting the mood of certain music (via the processing system/computer), the signal generator may output a signal to a television, projector, smoke generator, scent machine, electronic video display, or other electronic device to change the output thereof and match the mood of the music. In one instance, if an excited song or segment thereof were playing, the system could change the output of a smoke generator to generate more smoke and match the song. Likewise, the television or other such electronic display could output excited computer-generated images or video to match the song. Thus, alternate systems beyond lighting are possible.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will also be appreciated that the various dependent claims and the features set forth therein can be combined in different ways than presented in the initial claims, and that the features described in connection with individual embodiments may be shared with others of the described embodiments. In particular, as understood by one of skill in the art, the features of any dependent claim may be shared with a separate independent or dependent claim, to the extent feasible.

1. A lighting system comprising:
one or more lights;
an audio sensor;
a processing system having one or more processors and a memory communicatively coupled to each processor, each processor having instructions configured to:
analyze an audio signal received from the audio sensor; and
determine the mood of audio detected by the audio sensor based off a variety of descriptors embedded in the audio signal; and
a signal generator communicatively coupled to each light, the signal generator being operative to generate a signal reflective of the determined mood for receipt by each light, wherein light output from each light is altered in response to the signal received by the signal generator.

2. A lighting system as claimed in claim 1, wherein the audio sensor is a microphone.

3. A lighting system as claimed in claim 2, wherein the microphone is a directional microphone.

4. A lighting system as claimed in claim 3, wherein the directional microphone is embedded in each light or is common to an array of the one or more lights.

5. A lighting system as claimed in claim 1, wherein color, intensity, and/or modulation of light output from each light is altered in response to the signal received by the signal generator so as to match the determined mood of the audio received by the audio sensor.

6. A lighting system as claimed in claim 1, wherein the signal generator forms part of the processing system.

7. A lighting system comprising:
one or more lights;
a processing system having a processor and a memory communicatively coupled to the processor, the processor having instructions configured to:
analyze an audio signal; and
determine the mood of audio associated with the audio signal based off a variety of descriptors embedded in the audio signal; and
a signal generator communicatively coupled to each light, the signal generator being operative to generate a signal reflective of the determined mood for receipt by each light, wherein light output from each light is altered in response to the signal received by the signal generator.

8. A lighting system as claimed in claim 7, wherein color, intensity, and/or modulation of light output from each light is altered in response to the signal received by the signal generator so as to match the determined mood of the audio associated with the audio signal.

9. A lighting system as claimed in claim 7, wherein the processor includes instructions for running a mood algorithm configured to analyze the variety of descriptors embedded in the audio signal and determine the mood of the audio associated with the audio signal based off the descriptors.

10. A lighting system as claimed in claim 9, wherein the descriptors include a combination of the following:

| Type | Features |
|---|---|
| Low level | barkbands spread, skewness, kurtosis, |
| | dissonance, hfc pitch and confidence, pitch |
| | salience, spectral complexity spectral crest, |
| | spectral decrease, energy, spectral flux spec |
| | spread/skewness/kurtosis, spec rolloff, |
| | strong peak ZCR, barkbands, mfcc |
| Rhythm | bpm, beats loudness, onset rate |
| Sound FX | inharmonicity, odd2even, pitch centroid, |
| | tristimulus |
| Tonal | chords strength (frame), key strength |
| | (global), tuning freq |

11. A method of altering lighting comprising:
providing a processor, a memory communicatively coupled to the processor, a signal generator, and one or more lights;
generating and sending an audio signal to the processor;
analyzing the audio signal via the processor to determine the mood of audio associated with the audio signal, the analyzing step comprising assessing descriptors embedded within the audio signal determinative of the mood of the audio;
outputting a signal via the signal generator that is representative of the mood of the audio, as determined in the analyzing step; and
altering light generated by the one or more lights in response to the signal so that the generated light reflects the mood of the audio determined in the analyzing step.

12. A method of altering lighting as claimed in claim 11, further comprising altering the color, intensity, and/or modulation of light generated by the one or more lights in response to the signal so that the generated light reflects the mood determined in the analyzing step.

13. A method of altering lighting as claimed in claim 11, wherein the signal is a wireless signal sent from the signal generator to a receiver associated with the one or more lights.

14. A method of altering lighting as claimed in claim 11, further comprising:
associating a microphone with each light or an array of the one or more lights; and
detecting the audio using the microphone and converting said audio into the audio signal sent to the processor.

15. A method of altering lighting as claimed in claim 14, wherein the microphone is a directional microphone.

16. A method of altering the output of an electronic device comprising:
providing a processor, a memory communicatively coupled to the processor, a signal generator, and one or more electronic devices operable to output human-perceptible media;
generating and sending an audio signal to the processor;
analyzing the audio signal via the processor to determine the mood of audio associated with the audio signal, the analyzing step comprising assessing descriptors embedded within the audio signal determinative of the mood of the audio;
outputting a signal via the signal generator that is representative of the mood of the audio, as determined in the analyzing step; and
altering the quality or content of human-perceptible media output from the electronic device in response to the signal so that the human-perceptible media reflects the mood of the audio determined in the analyzing step.

17. A method of altering the output of an electronic device as claimed in claim 16, wherein the electronic device is a video display means.

18. A method of altering the output of an electronic device as claimed in claim 17, wherein the human-perceptible media is video.

19. A method of altering the output of an electronic device as claimed in claim 16, wherein the electronic device is a smoke generator.

20. A method of altering the output of an electronic device as claimed in claim 16, wherein the electronic device is a projector means.
